(19) United States
(12) Patent Application Publication
(10) Pub. No.: US 2014/0360613 A1
(43) Pub. Date: Dec. 11, 2014

(54) INSTRUMENTATION LINE PROTECTION AND SECUREMENT SYSTEM

(71) Applicants: Phillip E. Abshire, Lafayette, LA (US); Tyrone P. Dominique, Houston, TX (US); Randall V. Guest, Spring, TX (US)

(72) Inventors: Phillip E. Abshire, Lafayette, LA (US); Tyrone P. Dominique, Houston, TX (US); Randall V. Guest, Spring, TX (US)

(73) Assignee: BAKER HUGHES INCORPORATED, Houston, TX (US)

(21) Appl. No.: 13/912,588

(22) Filed: Jun. 7, 2013

(51) Int. Cl. F16L 9/14; F16L 55/00

(52) U.S. Cl. CPC F16L 9/14; F16L 55/00
USPC 138/104

(57) ABSTRACT

A screen assembly including a tubular screen member, an instrumentation line disposed at an outer radial surface of the tubular screen member and a shape-change element disposed radially outwardly of the instrumentation line. The shape-change element is configured to change in radial dimension in response to exposure to a corresponding stimulus in order to increasingly clamp the instrumentation line against the outer radial surface of the tubular screen member when transitioning from a first shape to a second shape. The shape-change element protects the instrumentation line radially between the tubular screen component and the shape-change element along an entire axial length of the shape-change element. A method of monitoring a borehole completion is also included.

### BACKGROUND

Cables, fiber optics, hydraulic control lines, chemical injection lines, and other instrumentation lines are ubiquitous in the downhole drilling and completions industry. These lines can be used for communicating fluids, signals, power, etc. to various downhole areas and/or devices as well as to enable the monitoring of desired parameters such as temperature, pressure, strain, acoustics, etc. The industry is always desirous of new instrumentation line systems.

### SUMMARY

A screen assembly, including a tubular screen member; an instrumentation line disposed at an outer radial surface of the tubular screen member; and a shape-change element disposed radially outwardly of the instrumentation line, the shape-change element configured to change in radial dimension in response to exposure to a corresponding stimulus in order to increasingly clamp the instrumentation line against the outer radial surface of the tubular screen member when transitioning from a first shape to a second shape, the shape-change element protecting the instrumentation line radially between the tubular screen component and the shape-change element along an entire axial length of the shape-change element.

A completion system, including a tubular member; an instrumentation line disposed with the tubular member at a circumferential surface of the tubular member; and a shape-change element circumferentially disposed with respect to tubular member to protectively capture the instrumentation line radially between the shape-change element and the circumferential surface of the tubular member along an axial length of the shape-change element, the shape-change element configured to change in radial dimension in response to a corresponding stimulus in order to increasingly clamp the instrumentation line against the circumferential surface of the tubular member when transitioning from a first shape to a second shape.

A method of monitoring a borehole completion including subjecting a shape-change element to a corresponding stimulus; transitioning the shape-change element from a first shape to a second shape to change at least one dimension of the shape-change element in response to the stimulus; increasingly clamping an instrumentation line against a surface of a tubular member with the shape-change element due to the transitioning to the second shape; and monitoring strain in the tubular member with the instrumentation line.

### BRIEF DESCRIPTION OF THE DRAWINGS

The following descriptions should not be considered limiting in any way. With reference to the accompanying drawings, like elements are numbered alike:

FIG. 1 is a cross-sectional view of a system having a shape-change element in a first shape according to one embodiment disclosed herein;

FIG. 2 is a cross-sectional view of the system of FIG. 1 with the shape-change element in a second shape facilitating securement of an instrumentation line to a tubular member with the shape-change element;

FIG. 3 is a cross-sectional view of the system of FIG. 1 taken generally along line 3-3;

FIG. 4 is a cross-sectional view of a system having a plurality of shape-change elements in a first shape according to one embodiment disclosed herein;

FIG. 5 is a cross-sectional view of the system of FIG. 4 with the shape-change elements in a second shape facilitating securement of an instrumentation line to a tubular member with the shape-change elements; and

FIG. 6 is a cross-sectional view of the system of FIG. 4 taken generally along line 6-6.

### DETAILED DESCRIPTION

A detailed description of one or more embodiments of the disclosed apparatus and method are presented herein by way of exemplification and not limitation with reference to the Figures.

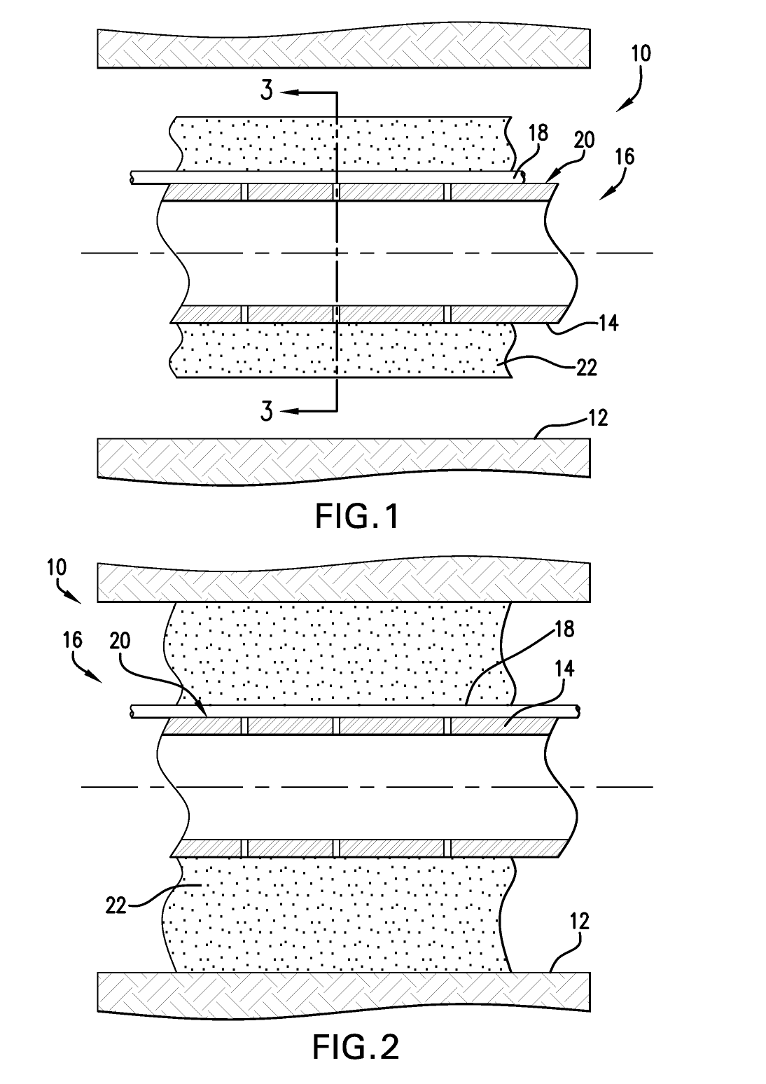

A system 10 is shown for completing a borehole 12 in FIGS. 1-3. More specifically, the system 10 includes one or more tubular members 14 arranged in or along a completion or tubular string. In the illustrated embodiment, the tubular member 14 is part of a screen assembly 16, and comprises sections of base pipe, filter media, mesh, wire-wrap, slotted or perforated tubulars, etc., or any combination thereof, generally for screening or filtering fluid from a downhole formation adjacent to the borehole 12. It is to be noted that the tubular member 14 could alternatively be part of a casing string, work string, or other string run into the borehole 12.

The system 10 includes an instrumentation line 18 for monitoring downhole parameters and/or controlling operation of the system 10 or other devices, mechanisms, or components disposed with or coupled to the tubular member 14. The instrumentation line 18 can generally include any power, signal, or communication line, including fiber optics, electrical cables, hydraulic control line, chemical injection lines, capillary tubes, conduits, etc. In one embodiment, the instrumentation line 18 is a fiber optic line having an integrated distributed sensing arrangement, e.g., via fiber Bragg gratings or the like formed within the line 18 at spaced intervals, to enable the sensing of desired parameters, e.g., temperature, pressure, strain, acoustics, etc., along the length of the instrumentation line 18. In a further embodiment, the line 18 is arranged as a fiber optic line specifically for measuring strain of the tubular components in real-time compaction imaging (RTCI) and real-time compaction monitoring (RTCM) operations. Alternatively, the instrumentation line 18 could include discrete sensors installed along the length of the line 18. In one embodiment, the instrumentation line 18 is in power and/or signal communication with an actuatable device, e.g., a valve, for triggering actuation of the device.

The instrumentation line 18 is disposed at a circumferential surface 20 of the tubular member 16. An adhesive, e.g., epoxy, may be included to at least temporarily secure the instrumentation line 18 in place. One or more shape-change element 22 are disposed radially outwardly of the instrumentation line 18, such that the instrumentation line 18 is disposed between the shape-change element 22 and the outer surface 20 of the tubular member 14. In the illustrated embodiment, the shape-change element 22 is arranged as a generally annular shaped sleeve, jacket, or volume of shape-change material extending longitudinally along the string formed by the tubular member 14.

The shape-change element 22 is configured to transition from a first or initial shape into a second shape. During the transition from the first shape to the second shape, at least one dimension of the element 22 is altered. That is, in the illustrated embodiment, the shape-change element 22 is arranged to change shape with respect to the radial direction, such that the shape-change element 22 increasingly firmly clamps, secures, or couples the instrumentation line 18 to the tubular members 14 at the surface 20. Advantageously, securing the instrumentation line 18 with the shape-change element 22 avoids the need to machine a groove or recess into the tubular member 14 in which to hold an instrumentation line, e.g., as is used in many known RTCI, RTCM, and other sensing systems. These machined grooves are relatively time consuming and costly to create and reduce the mechanical properties of tubular members in which they are made.

The shape-change element 22 is illustrated in FIG. 1 being as relatively loosely disposed about the tubular member 14, which enables the shape-change element 22 to be arranged about the instrumentation line 18 and the tubular member 14 and/or the instrumentation line 18 to be arranged radially between the shape-change element 22 and the tubular member 14. That is, the element 22 can be installed after or before the instrumentation line 18 is positioned at the surface 20 of the tubular member 14. In FIG. 2, the element 22 has undergone a shape-change, notably, extension in the radial direction, e.g., radially inwardly and/or radially outwardly. As noted above, radially inward extension will facilitate in the supporting the instrumentation line 18 against the surface 20 of the tubular member 14. Radially outward extension may help centralize the tubular member 14 within the borehole 12, support the walls of the borehole 12, etc. In one embodiment, the shape-change element is a permeable material, e.g., shape memory foam, which enables fluid flow therethrough (e.g., hydrocarbon production), while screening particulates such as sand.

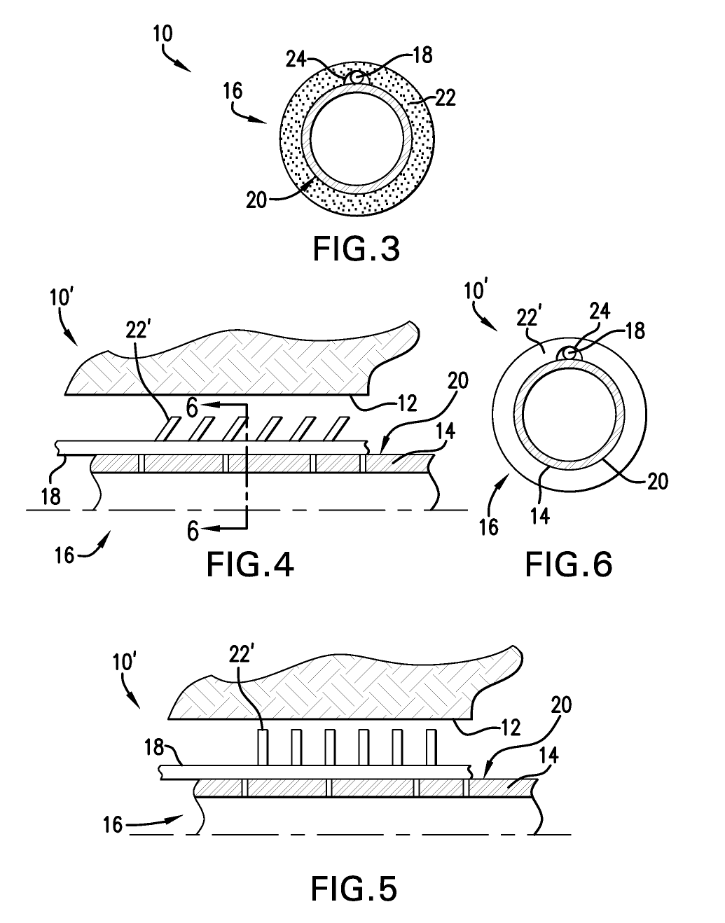

FIG. 3 illustrates a groove, recess, slot, or other grooves 24 (generally, the “groove 24”) in the shape-change element 22 arranged to accommodate assembly of the instrumentation line 18 and the element 22 together. After undergoing shape change, the grooves 24 will compress around the instrumentation line 18 in order to support the instrumentation line 18 against the tubular member 14 with the element 22. In other embodiments, the shape-change element 22 will not include the grooves 24 and the inner diameter or dimension of the element 22 will simply deform about the instrumentation line 18. The presence, absence, and/or depth of the grooves 24, along with the known or expected dimensional change of the element 22 can be used to tailor the force exerted by the shape-change element 22 on the instrumentation line 18. In this way, the line 18 can be secured attached to the tubular member 14 without risk of damage to the instrumentation line 18. The instrumentation line 18 can be arranged extending generally longitudinally parallel to the tubular member 14, or in some other arrangement, such as helically about the tubular member 14, with the grooves 24 being complementarily formed to accommodate these and other orientations of the instrumentation line 18 with respect to the tubular member 14.

The shape change of the element 22, i.e., the change in one or more dimensions of the element 22, can be triggered in response to a selected stimulus applied to the shape-change element 22. For example, in one embodiment the shape-change element 22 includes a shape-memory material, e.g., a shape-memory polymer, which reverts to a remembered or default shape upon exposure to a corresponding stimulus such as temperature, pH, electric current, magnetic field, activation fluid, etc. The shape-change element 22 could also include a shape-change alloy, which may additionally be coated in a relatively more pliable material in order to prevent pinching or other damage to the instrumentation line 18 during the shape-change process. In one embodiment, the shape-change element 22 is a swellable material and the corresponding stimulus includes exposure to a selected fluid such as oil or water. The stimulus may be naturally present within the borehole 12 and/or the downhole environment, e.g., borehole fluids, ambient temperature, etc., or could be selectively supplied to trigger the shape change.

In addition to securing the instrumentation line 18 to the tubular member 14, the shape-change element 22 being arranged radially outwardly of the instrumentation line 18 also enables the element 22 to protect the instrumentation line 18 along the full length or axial dimension of the shape-change element 22. In this way, the axial length of the shape-change element can be selected to both protect the line 18 and to secure the instrumentation line 18 along a desired length of the tubular member 14 and/or multiple joints or sections of the members 14.

A system 10′ according to another embodiment is shown in FIGS. 4-6. The system 10′ resembles the system 10 in many respects, and includes the tubular member 14, e.g., of the screen assembly 16, disposed with the instrumentation line 18 at the surface 20 of the tubular member 14. In lieu of the shape-change element 22, the system 10′ includes a plurality of shape change elements 22′. The elements 22′ are illustrated in the shape of brushes, cones, or rings, but otherwise generally resemble the shape-change element 22. That is, the elements 22′ each undergo a shape change to alter one or more dimensions of the elements 22′, e.g., to facilitate the securement of the instrumentation line 18 to the tubular member 14. For example, the elements 22′ are relatively loosely disposed about the tubular member 14 in FIG. 4 and extend or expand radially inwardly and/or outwardly during the shape change process to firmly secure the instrumentation line 18 to the tubular member 14. The elements 22′ may also centralize the tubular member 14 within the borehole 12, support the walls of the borehole 12, protect the instrumentation during and after run-in, etc., as discussed above with respect to the element 22.

The number of the elements 22′ and the spacing therebetween can be set with respect to the desired purpose of the instrumentation line 18. For example, if the instrumentation line 18 is a fiber optic line arranged to sense strain in the tubular member 14, a relatively large number of closely spaced ones of the elements 22′ can be included to firmly and consistently couple the instrumentation line 18 to the tubular 14 for maintaining a sufficiently high resolution of strain sensing by the line 18. It is also to be understood, as shown in FIG. 6, that each of the elements 22′ can include one of the grooves 24 to facilitate the arrangement and assembly of the system 10′.

It is to be appreciated that the shape-change elements can be arranged in other shapes not illustrated in the Figures. For example, in embodiments in which the instrumentation line is helically wrapped about a tubular member, the shape-change element(s) can be corresponding formed as a helically shaped member that follows the same helical path as the instrumentation line about the tubular member. The shape-change elements can be shapes other than annular, such as with edges, corners, or other features that become deformed against the instrumentation line and/or borehole wall, e.g., to help increase the force exerted by the shape-change elements to hold the instrumentation lines in place.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A screen assembly, comprising:
a tubular screen member;
an instrumentation line disposed at an outer radial surface of the tubular screen member; and
a shape-change element disposed radially outwardly of the instrumentation line, the shape-change element configured to change in radial dimension in response to exposure to a corresponding stimulus in order to increasingly clamp the instrumentation line against the outer radial surface of the tubular screen member when transitioning from a first shape to a second shape, the shape-change element protecting the instrumentation line radially between the tubular screen component and the shape-change element along an entire axial length of the shape-change element.

2. The screen assembly of claim 1, wherein the tubular screen member is a base pipe, a slotted tubular, a perforated tubular, a wire-wrapped tubular, a mesh layer, or a combination including at least one of the foregoing.

3. The screen assembly of claim 1, wherein the shape-change element is a shape memory material.

4. The screen assembly of claim 3, wherein the shape memory material is a shape memory polymer.

5. The screen assembly of claim 3, wherein the shape memory material is a shape memory foam.

6. The screen assembly of claim 5, wherein the shape memory foam is permeable to enable production of borehole fluids into the tubular member while impeding the flow of solid particulates.

7. The screen assembly of claim 1, comprising a plurality of the shape-change elements.

8. The screen assembly of claim 1, wherein the shape-change element is arranged to contact walls of a borehole in which the assembly is positioned after transitioning to the second shape.

9. The screen assembly of claim 1, wherein the instrumentation line is configured for monitoring one or more parameters related to operation of the screen assembly.

10. The screen assembly of claim 9, wherein the one or more parameters includes strain in the tubular member.

11. The screen assembly of claim 9, wherein the instrumentation line includes optical fibers.

12. The screen assembly of claim 1, wherein the instrumentation line is arranged to communicate electrical signals, electrical power, hydraulic pressure, chemicals, or a combination including at least one of the foregoing.

13. The screen assembly of claim 1, wherein the shape-change element includes a swellable material and the corresponding stimulus relates to a selected fluid.

14. The screen assembly of claim 1, wherein the shape-change element is provided with a groove for accommodating positioning of the instrumentation line with respect to the shape-change element.

15. A completion system, comprising:
a tubular member;
an instrumentation line disposed with the tubular member at a circumferential surface of the tubular member; and
a shape-change element circumferentially disposed with respect to tubular member to protectively capture the instrumentation line radially between the shape-change element and the circumferential surface of the tubular member along an axial length of the shape-change element, the shape-change element configured to change in radial dimension in response to a corresponding stimulus in order to increasingly clamp the instrumentation line against the circumferential surface of the tubular member when transitioning from a first shape to a second shape.

16. A method of monitoring a borehole completion comprising:
subjecting a shape-change element to a corresponding stimulus;
transitioning the shape-change element from a first shape to a second shape to change at least one dimension of the shape-change element in response to the stimulus;
increasingly clamping an instrumentation line against a surface of a tubular member with the shape-change element due to the transitioning to the second shape; and
monitoring strain in the tubular member with the instrumentation line.

17. The method of claim 16, wherein the instrumentation line includes optical fibers.

18. The method of claim 17, wherein the optical fibers are helically wrapped about the tubular member.
